(19) United States
(12) Patent Application Publication
(10) Pub. No.: US 2006/0270438 A1
(43) Pub. Date: Nov. 30, 2006

(54) Wireless personal area network device and method for controlling beacon reception thereof

(76) Inventor: Soon Jin Choi, Kyungki-do (KR)

Correspondence Address: LOWE HAUPTMAN BERNER, LLP, 1700 DIAGONAL ROAD, SUITE 300, ALEXANDRIA, VA, 22314, US

(21) Appl. No.: 11/410,001

(22) Filed: Apr. 25, 2006

(30) Foreign Application Priority Data
May 3, 2005 (KR) 10-2005-037190

(51) Int. Cl. H04B 7/00

(52) U.S. Cl. 455/522

(57) ABSTRACT

The invention provides a wireless personal area network (WPAN) device, in which a beacon reception interval is set to vary in response to data reception and the power level of the device and a method for controlling beacon reception thereof. The WPAN device includes a receiver for receiving beacons at a predetermined interval, a frame analyzer for analyzing beacons, and a data-storing part for storing the information analyzed by the frame analyzer. The device further includes a traffic monitor for monitoring data reception, a power level detector for detecting power level, a beacon interval setter for setting the beacon interval in response to data reception and the power level, and a reception controller for controlling the beacon reception according to the set interval. A method for managing low power consumption in the WPAN device is also proposed.

### CLAIM OF PRIORITY

This application claims the benefit of Korean Patent Application No. 2005-37190 filed on May 3, 2005, in the Korean Intellectual Property Office, the disclosure of which is incorporated herein by reference.

### BACKGROUND OF THE INVENTION

1. Field of the Invention

The present invention relates to a Wireless Personal Area Network (WPAN) which is synchronized by using beacons, and more particularly, a WPAN device, which is synchronized by periodically receiving beacons, in which a beacon reception interval is set to vary in response to data reception and the power level of the device, preventing unnecessary power consumption, thereby minimizing overall power consumption, and a method of controlling the beacon reception thereof.

2. Description of the Related Art

In general, a Wireless Personal Area Network (WPAN), which is synchronized by using beacons, is composed of a wireless personal area network coordinator for transmitting beacons at predetermined intervals and a plurality of wireless personal area network devices for receiving beacons from the coordinator. There have been studies and development for a way to minimize power consumption in the plurality of WPAN devices which periodically receive beacons to be synchronized with the network.

Such a WPAN is explained with reference to FIGS. 1 and 2.

FIG. 1 is a view illustrating the concept of reception and transmission of beacons in the WPAN.

The WPAN shown in FIG. 1 includes a coordinator 10 for managing the WPAN while transmitting beacons at a predetermined interval, and a plurality of devices 20-1 to 20-n for receiving the beacons from the coordinator 10. The WPAN coordinator 10 establishes a network and periodically transmits the beacons. The wireless personal area network device 20-1 to 20-n periodically receives the beacons from the WPAN coordinator 10 to conduct communication in constant time-synchronization with the WPAN coordinator 10. Here, the WPAN coordinator 10 determines the beacon transmission interval, which varies mainly according to application services, and the beacon reception interval which is initially set is not changed during the operation.

In addition, the conventional WPAN coordinator 10 transmits the beacons at a predetermined interval. It continuously transmits the beacons at a predetermined interval regardless of whether or not the WPAN devices 20-1 to 20-n receives the beacons. This is to allow a new device to additionally connect to the wireless personal area network. Therefore, all devices in the wireless personal area network are configured to receive the beacons from the coordinator at predetermined interval.

FIG. 2 is a flow chart illustrating a conventional process of beacon reception.

As shown in FIGS. 1 and 2, each device checks whether or not it is the time for beacon reception set by the coordinator in S31, and if so, receives and processes the beacons from the coordinator in S32. Such a process of receiving at a predetermined beacon reception interval is repeated until the device comes to an end in S33.

As such, the conventional WPAN devices receive all beacons transmitted at a predetermined interval from the coordinator to maintain synchronism. Thus, all devices receive beacons at a predetermined interval even though some of them may have no data to receive or transmit.

Therefore, the conventional WPAN device receives all beacons unconditionally even though not much power is left in itself, and therefore may exhaust its power receiving only beacons before it receives the data.

### SUMMARY OF THE INVENTION

The present invention has been made to solve the foregoing problems of the prior art and it is therefore an object of the present invention to provide a Wireless Personal Area Network (WPAN) device, which is synchronized by periodically receiving beacons, in which a beacon reception interval is set to vary in response to whether or not data is received and according to the power level of the device, preventing unnecessary power consumption, thereby minimizing overall power consumption, and a method of controlling the beacon reception thereof.

According to an aspect of the invention for realizing the object, there is provided a WPAN device including: a receiver for receiving a beacon from a wireless personal area network coordinator at a predetermined beacon reception interval; a frame analyzer for analyzing information including a beacon order, a superframe order and a pending address contained in the beacon received by the receiver; a data-storing part for storing the information analyzed by the frame analyzer; a traffic monitor for monitoring data reception based on the pending address analyzed by the frame analyzer; a power level detector for detecting power level of a power supplier which supplies needed power to each part; a beacon interval setter for setting the beacon reception interval in response to whether or not the data is received by the traffic monitor and according to the power level detected by the power level detector; and a reception controller for controlling the beacon reception according to the beacon reception interval set by the beacon interval setter.

In the WPAN device, the beacon interval setter sets a basic interval calculated from the beacon order as the beacon reception interval if data reception by the traffic monitor takes place within a reference time period or if the power level detected by the power level detector is higher than a reference power level. It also sets a power-saving interval calculated according to the beacon order and the power level as the beacon reception interval if data reception does not take place within the reference time period or if the power level detected by the power level detector is lower than the reference power level.

The power-saving interval is calculated according to an equation of SD*2^{PSO}, where PSO is a power-saving order obtained from adding the beacon order to the power level, and SD is a predetermined superframe duration.

The power-saving order is set within a range permitted by the beacon order.

The power-saving interval is set within a time period for processing medium access control.

According to another aspect of the invention for realizing the object, there is also provided a method for controlling beacon reception in a WPAN including steps of: setting a basic interval calculated according to a beacon order as a beacon reception interval; receiving a beacon at the set beacon reception interval and detecting the internal power level; determining whether or not data is received based on a pending address contained in the received beacon; determining whether or not the detected power level is below a reference power level if there is no data reception within a reference time period; resetting a power-saving interval calculated according to the beacon order and the power level as the beacon reception interval if the detected power level is below the reference power level; and restoring the basic interval calculated according to the beacon order as the beacon reception interval if there is data reception within the reference time period or the detected power level is not below the reference power level.

The method further includes, if an end is selected, terminating the beacon reception process, and if the end is not selected, setting the beacon reception interval according to reception status and the power level and returning to the step of receiving the beacon.

The power-saving interval is calculated according to an equation of SD*2^{PSO}, where PSO is a power-saving order obtained from adding the beacon order to the power level, and SD is a predetermined superframe duration.

The power-saving order is set within a range permitted by the beacon order.

The power-saving interval is set within a time period for processing medium access control.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating the concept of reception and transmission of beacons in a wireless personal area network (WPAN);

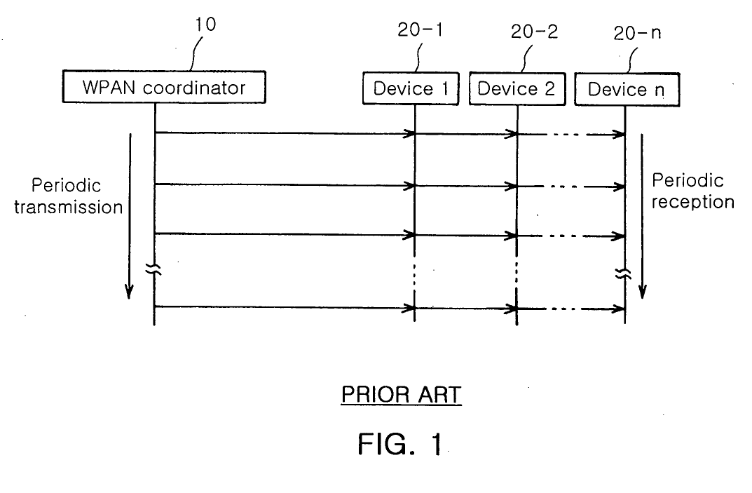

FIG. 2 is a flow chart illustrating a conventional reception process of beacons;

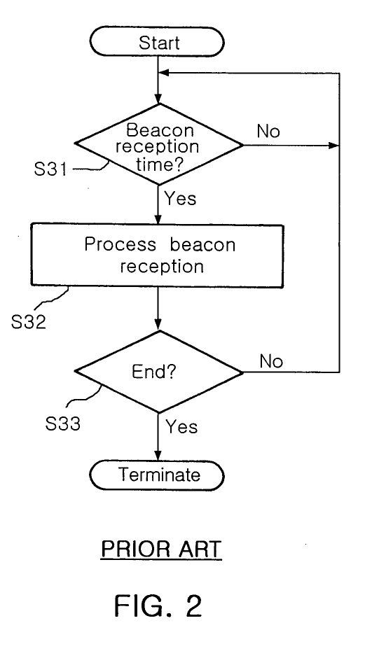

FIG. 3 is a block diagram illustrating a WPAN device according to the present invention;

FIG. 4 is a structural view illustrating a beacon frame received by the WPAN device;

FIG. 5 is a flow chart illustrating a method of controlling beacon reception in a WPAN device;

FIG. 6 is a graph illustrating an example in which the beacon reception interval is varied according to different power levels; and

FIG. 7 is a view illustrating an example of beacon transmission and reception according to the power level.

### DETAILED DESCRIPTION OF THE PREFERRED EMBODIMENT

Preferred embodiments of the present invention will now be described in detail with reference to the accompanying drawings. The same reference numerals are used throughout the different drawings to designate the components having the substantially the same constitutions and functions.

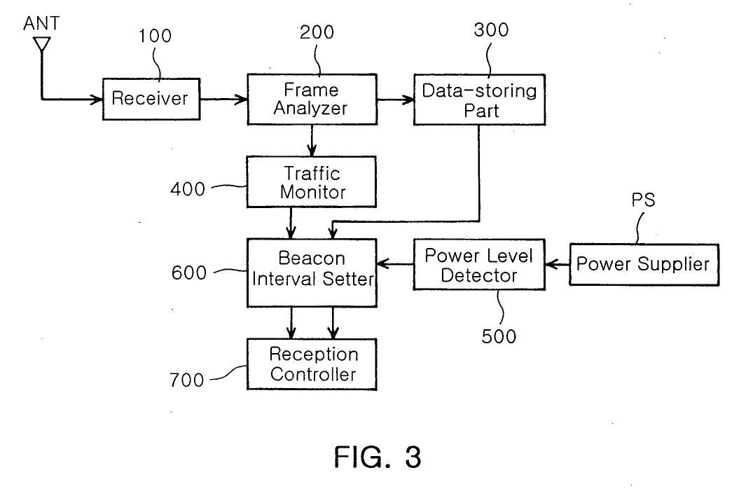

FIG. 3 is a block diagram illustrating a wireless personal area network (WPAN) device according to the present invention.

With reference to FIG. 3, the WPAN device according to the present invention includes: a receiver 100 for receiving a beacon from a WPAN coordinator at a predetermined beacon reception interval; a frame analyzer 200 for analyzing information including a beacon order BO, a superframe order SO and a pending address PA contained in the beacon received by the receiver 100; a data-storing part 300 for storing the data analyzed by the frame analyzer; a traffic monitor 400 for monitoring whether or not data is received based on the pending address analyzed by the frame analyzer 200; a power level detector 500 for detecting the power level of the power supplier which supplies needed power to each power; a beacon interval setter 600 for setting a basic interval calculated according to whether or not data is received by the traffic monitor 400 and the power level detected by the power level detector 500 as the beacon reception interval; and a reception controller 700 for controlling the beacon reception by the receiver 100 according to the beacon reception interval set by the beacon interval setter 600.

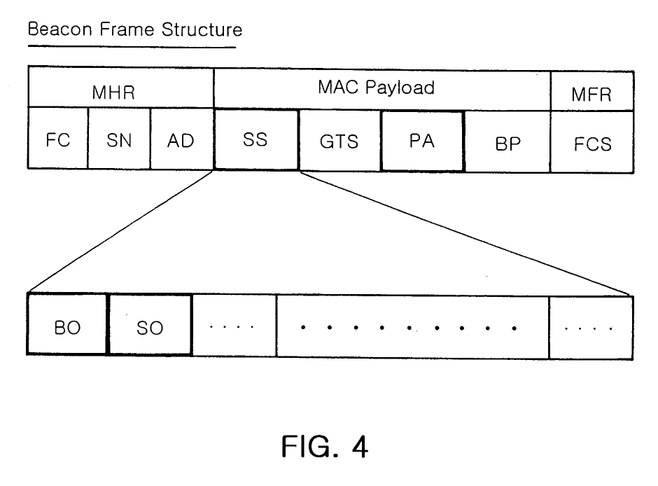

FIG. 4 is a structural view illustrating a frame structure of the beacon used in IEEE 802.15.4 system received by the WPAN device.

The beacon frame shown in FIG. 4 includes a Medium Access Control (MAC) header MHR, a MAC payload and a MAC footer MFR.

The MAC header MHR includes a frame control field FC having a beacon identifier, a sequence number field SN for representing a sequence number for a current frame, and an address field AD containing source address. The MAC payload includes a superframe specification field for defining logical time slot for time management of reception and transmission, a guaranteed time slot containing information for providing guaranteed time slot to a particular device, a pending address field PA containing address of the device to which data needs to be transmitted, and a beacon payload. In addition, the MAC footer MFR includes a frame check sum FCS for checking errors of the frame being transmitted.

In addition, the superframe specification field SS includes a beacon order containing information of beacon transmission interval and a superframe order containing information of the superframe duration.

The beacon interval setter 600 calculates a basic interval according to the beacon order BO and sets this basic interval as the beacon reception interval BI, if the data reception by the traffic monitor 500 takes place within a reference time period or if the power level PL detected by the power level detector is higher than a reference power level. On the other hand, if there is no data reception within the reference time period and the power level PL detected by the power level detector is lower than the reference power level, the beacon interval setter 600 calculates a power-saving interval according to the beacon order BO and the power level PL and sets this power-saving interval as the beacon reception interval BI.

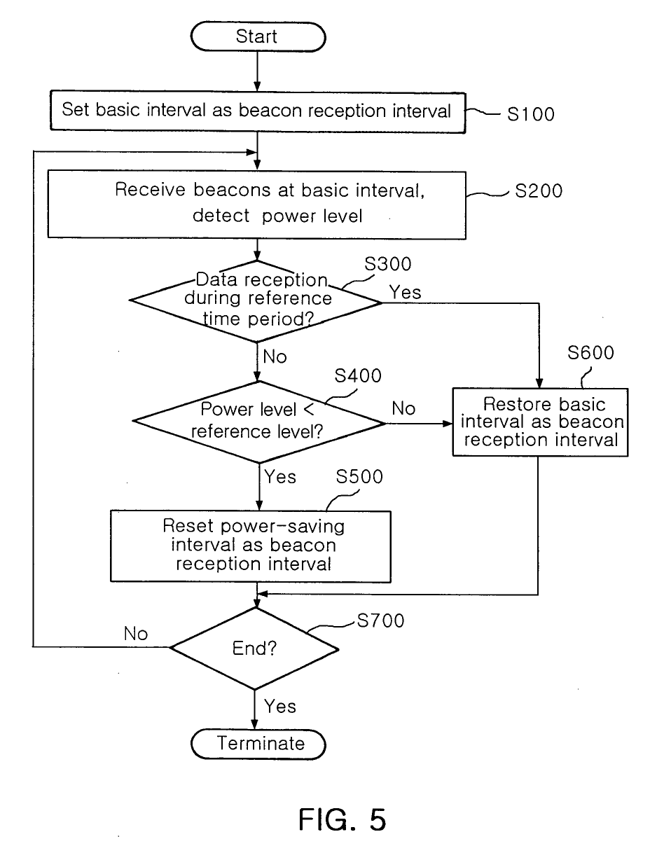

FIG. 5 is a flow chart illustrating a method for controlling beacon reception in the WPAN device. FIG. 5 shows the process of controlling the beacon reception according to the beacon order BO and the power level PL in the wireless personal area network device according to the present invention.

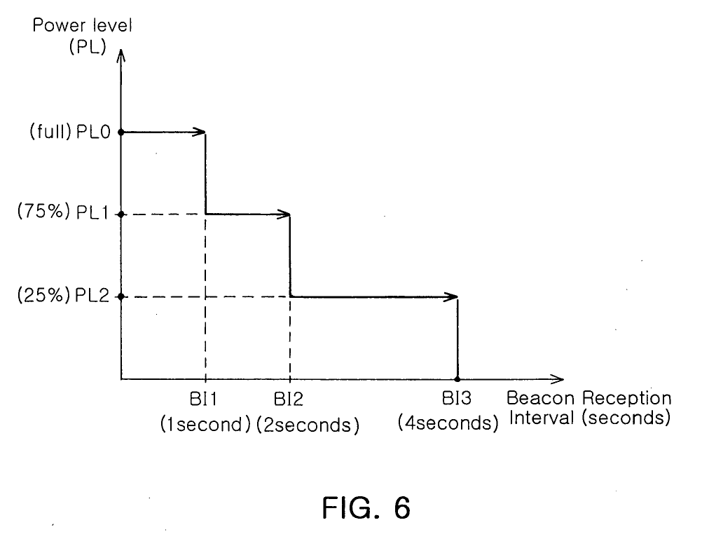

FIG. 6 is a graph showing an example in which the beacon reception interval is set for different power levels according to the present invention. In FIG. 6, the beacon reception intervals are set differently according to the power levels.

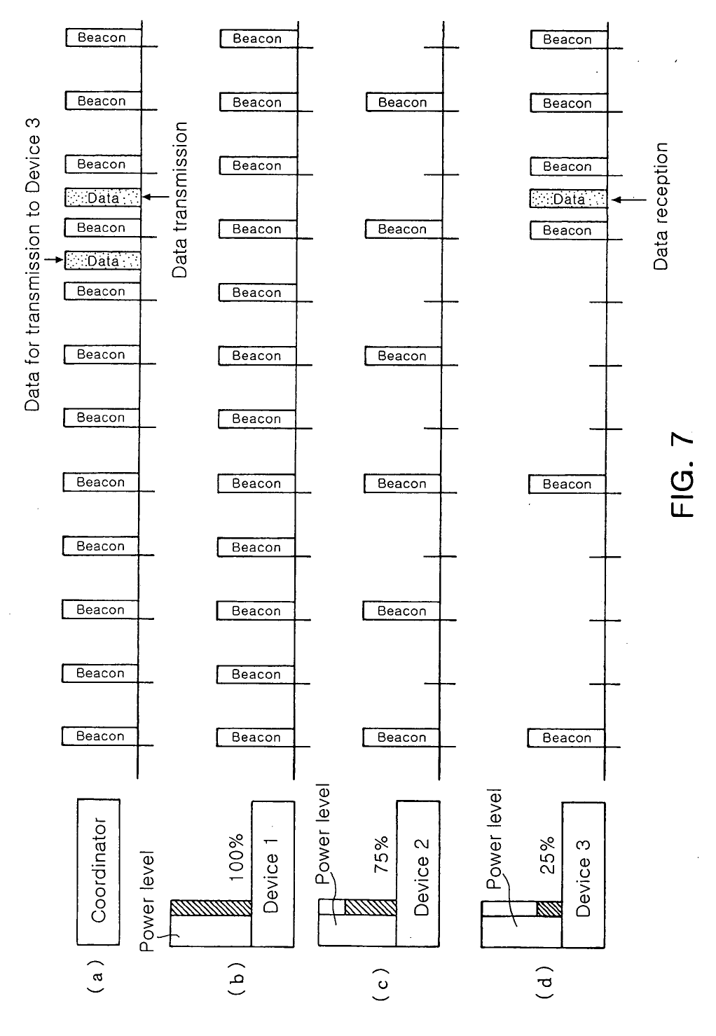

FIG. 7 is a view of an example showing beacon reception and transmission for different power levels according to the present invention. FIG. 7(a) is an example of beacons transmitted at a predetermined transmission interval from the WPAN coordinator. FIG. 7(b) shows the beacon reception interval in device 1 having the power level of 100%, and FIG. 7(c) shows the beacon reception interval in device 2 having the power level of 75%. And FIG. 7(d) shows the beacon reception interval in device 1 having the power level of 25%.

Now, the operations and effects of the present invention will be explained in detail with reference to the accompanying drawings.

The WPAN coordinator which communicates with the WPAN device of the present invention conducts scanning in a beginning stage of network establishment, and completes establishment of a channel between the coordinator and the device through an association process of the wireless personal area network device. Through these processes, each wireless personal area network device and the wireless personal area network coordinator become ready to telecommunicate data.

As shown in FIG. 7, the WPAN devices of the invention receive the beacons transmitted by the WPAN coordinator at a predetermined beacon reception interval. At this point, the beacon reception interval is determined according to the data reception status and the power level of the device, which will be explained hereunder.

With reference to FIGS. 3 to 7, in the initial beacon-setting stage S100, a basic interval calculated according to the beacon order BO is set as the beacon reception interval BI. In this stage, once the WPAN is established, the receiver 100 of the wireless personal area device of the present invention detects and receives the beacons transmitted periodically from the wireless personal area network coordinator. Afterwards, the beacons received by the receiver 100 are analyzed by the frame analyzer 200 to be stored in the data-storing part 300. At this point, the frame analyzer 200, as shown in FIG. 4, analyzes information contained in the beacons, for example, the beacon order BO, the superframe order SO and the pending address PA.

At this point, the beacon interval setter 600 calculates a basic interval in the beginning stage according to following equation 1 using the beacon order and sets the basic interval as the beacon reception interval BI.
BasicInterval=SD×2^{BO} Equation 1

Here, SD indicates a superframe duration.

Next, in the beacon reception stage S200, the beacons are received at the predetermined beacon reception intervals BI, and the internal power level PL is detected. As described above, the beacons received by the receiver 100 of the WPAN device of the present invention is analyzed by the frame analyzer 200 and stored in the data-storing part 300. The power level detector 500 of the present invention detects the power level of the power supplier which supplies operating power needed for each part and sends the detected level to the beacon interval setter 600.

Next, in the stage of determining data reception S300, it is determined whether or not data is received based on the pending address contained in the received beacons. In this stage of determining data reception, the traffic monitor 400 of the present invention monitors whether or not data is received based on the pending address analyzed by the frame analyzer 200. For example, if the pending address belongs to a particular device, the device determines that there is to be or is data reception, and if the pending address does not belong to the device, the device determines that there is no data reception.

Next, in the stage of determining power level S400, if there is no data reception within the reference time period, the device determines whether the detected power level is below the reference power level. Here, the reference time period and the reference power level can be set according to the environment in which the WPAN is used. For example, the reference time period can be set 1 minute or 10 minutes, etc., and the reference power level can be set 80% or 75%, etc. of full charge.

Next, in the stage of resetting the beacon S500, if the detected power level is below the reference power level, the power-saving interval calculated according to the beacon order BO and the power level PL is set as the beacon reception interval BI. That is, if the data reception by the traffic monitor 500 takes place within the reference time period or the power level PL detected by the power level detector is higher than the reference power level, the beacon interval setter 600 calculates the basic interval according to the beacon order BO by above Equation 1 and sets the basic interval as the beacon reception interval BI.

With reference to FIG. 7(a), the WPAN Coordinator periodically transmits the beacons according to the beacon reception interval set by itself. The beacons are received by all the devices within the network.

As shown in FIG. 7(b), when the WPAN device 1 has sufficient power (100%) or there is data reception, it receives the beacons at the same interval as set by the WPAN coordinator.

On the other hand, when there is no data reception within the reference time period or the power level PL detected by the power level detector 500 is lower than the reference power level, the beacon interval setter 600 calculates a power-saving interval according to the beacon order BO and the power level PL and sets this power-saving interval as the beacon reception interval BI. Here, the power-saving interval is calculated according to following Equation 2 using a power-saving order obtained from adding the beacon order BO and the power level PL, and the predetermined superframe duration (SD).
PowerSavingInterval=SD×2^{PSO} Equation 2

In above Equation 2, the power-saving order should be set within a range (0≦PSO≦14) acceptable with the beacon order. In addition, the power-saving interval should be set within a MAC transaction persistence time.

Designating that PL=0 when the power level of the power supplier PS is at the highest, and that PL=1, PL=2, . . . , and PL=LK as the power level is gradually decreased, the beacon reception interval, which is the power-saving interval, can be represented in following Table 1. Referring to following Table 1, as the power level PL is decreased, the beacon interval is increased.

TABLE 1

| Power Level (PL) | Beacon Interval (BI) | Note |
|---|---|---|
| 0 | SD × 2 \hat{ } (BO + 0) | Receiving all beacons |
| 1 | SD × 2 \hat{ } (BO + 1) | |
| 2 | SD × 2 \hat{ } (BO + 2) | |
| . . . | SD × 2 \hat{ } (BO + . . .) | |
| LK | SD × 2 \hat{ } (BO + LK) | |

For example, in the above Equation 2, when SD equals to 32 msec, and BO equals to 5, the power level becomes 0 when fully charged. Thus the beacon reception interval BI is about 1 second (32* 2⁵=1024 msec), or when the power level becomes lower and becomes 1, the beacon reception interval BI is about 2 seconds (32*2⁶=2048 msec). If the power level PL further becomes as low as 2, the beacon reception interval BI is about 4 seconds (32*2⁶=4096 msec).

As described so far, the WPAN device can vary the beacon interval depending on its power status at any time, and the variable length of the interval can be set differently.

For example, with reference to FIG. 6, given that the beacon interval is set 1 second, when the power level is at the highest, the beacon interval can be maintained at the same interval of 1 second. However, the length of the beacon interval can be varied differently, for example, when the power level is lower, the beacon interval can be reset from 1 second to 2 seconds, and when the power level is even lower, the beacon interval can be reset from 1 second to 4 seconds.

When the WPAN device sets the beacon reception interval, the interval can be set up to the maximum interval allowed in the corresponding WPAN. Therefore, within the maximum reception interval allowed in an average WPAN, reception of beacons is ensured however long the beacon reception interval is.

Next, in the stage of restoring the beacon reception interval S600, when the data reception takes place within the reference time period or the detected power level is not below the reference power level, that is, when the data reception takes place or the power supplier PS has sufficient power, the basic interval calculated according to the beacon order BO by above Equation 1 is set as the beacon interval BI to restore the initial beacon interval as the beacon reception interval.

As shown in FIG. 7(c), in case of no data reception in WPAN device 2, the beacon interval is appropriately adjusted according to the power status (75%) and in response to whether or not there is data reception. In addition, as shown in FIG. 7(d), in case of no data reception in WPAN device 3, the beacon interval is appropriately adjusted according to the power status of itself (25%) and in response to whether or not there is data reception.

Therefore, when there is no data reception during a predetermined period of time, the beacon interval can be set longer to minimize unnecessary power consumption.

For example, in the case of device 2 and device 3 shown in FIGS. 7(c) and (d), if the devices recognized that the power is not much left in themselves and there has not been data reception during a predetermined period of time, the beacon interval can be set longer than the interval at which the beacons are received from the coordinator. Each device wakes up at each beacon interval but maintains a power-off state during other times to minimize power consumption.

Next, in the returning stage S700, if an end is selected, the process is terminated. But if the end is not selected, the beacon interval BI is set according to the data reception status and the power level of the device and the process returns to the beacon reception stage S200 to receive the beacon at the initially set beacon interval. Therefore, the beacon interval can be determined according to the power status and data reception status to prevent waste of unnecessary power during the times when there is no transmission or reception of data.

As shown in FIG. 7(d), in case where the WPAN device 3 receives data from the coordinator while the beacon reception interval is adjusted longer, the initial beacon interval is restored immediately so that the device receives all the beacons the WPAN coordinator is transmitting. And when data is not received or transmitted even after a certain period of time has passed, the device intermittently receives the beacons at the beacon interval set according to the power level of itself.

According to the present invention set forth above, in a WPAN, which is synchronized by periodically receiving beacons, a WPAN device is designed to set a beacon reception interval varying in response to data reception and the power level of the device, preventing unnecessary power consumption, thereby minimizing overall power consumption.

Accordingly, in the present invention, the beacon reception interval is determined flexibly according to the state of the device to minimize power consumption. Also, the initial beacon reception interval set by the WPAN coordinator can be restored in accordance with the data transmission and reception status of the device, and thus the device can flexibly adapt to whether there is data to receive or not. In addition, the length of the beacon reception interval can be varied differently according to the power level of the device to optimize power consumption.

While the present invention has been shown and described in connection with the preferred embodiments, it will be apparent to those skilled in the art that modifications and variations can be made without departing from the spirit and scope of the invention as defined by the appended claims.

What is claimed is:

1. A wireless personal area network device comprising:
a receiver for receiving a beacon from a wireless personal area network coordinator at a predetermined beacon reception interval;
a frame analyzer for analyzing information including a beacon order, a superframe order and a pending address contained in the beacon received by the receiver;
a data-storing part for storing the information analyzed by the frame analyzer;
a traffic monitor for monitoring data reception based on the pending address analyzed by the frame analyzer;
a power level detector for detecting power level of a power supplier which supplies needed power to each part;
a beacon interval setter for setting the beacon reception interval in response to whether or not the data is received by the traffic monitor and according to the power level detected by the power level detector; and
a reception controller for controlling the beacon reception according to the beacon reception interval set by the beacon interval setter.

2. The wireless personal area network device according to claim 1, wherein the beacon interval setter calculates a basic interval from the beacon order and sets the basic interval as the beacon reception interval if data reception by the traffic monitor takes place within a reference time period or if the power level detected by the power level detector is higher than a reference power level, and
calculates a power-saving interval according to the beacon order and the power level and sets the power-saving interval as the beacon reception interval if data reception does not take place within the reference time period or if the power level detected by the power level detector is lower than the reference power level.

3. The wireless personal area network device according to claim 2, wherein the power-saving interval is calculated according to an equation of SD*2^{PSO}, where PSO is a power-saving order obtained from adding the beacon order to the power level, and SD is a predetermined superframe duration.

4. The wireless personal area network device according to claim 3, wherein the power-saving order is set within a range permitted by the beacon order.

5. The wireless personal area network device according to claim 3, wherein the power-saving interval is set within a time period for processing medium access control.

6. A method for controlling beacon reception in a wireless personal area network device comprising steps of:
setting a basic interval calculated according to a beacon order as a beacon reception interval;
receiving a beacon at the set beacon reception interval and detecting the internal power level;
determining whether or not data is received based on a pending address contained in the received beacon;
determining whether or not the detected power level is below a reference power level if there is no data reception within a reference time period;
resetting a power-saving interval calculated according to the beacon order and the power level as the beacon reception interval if the detected power level is below the reference power level; and
restoring the basic interval calculated according to the beacon order as the beacon reception interval if there is data reception within the reference time period or the detected power level is not below the reference power level.

7. The method for controlling beacon reception in a wireless personal area network device according to claim 6, further comprising:
if an end is selected, terminating the beacon reception process, and if the end is not selected, setting the beacon reception interval according to reception status and the power level and returning to the step of receiving the beacon.

8. The method for controlling beacon reception in a wireless personal area network device according to claim 6, wherein the power-saving interval is calculated according to an equation of SD*2^{PSO}, where PSO is a power-saving order obtained from adding the beacon order to the power level, and SD is a predetermined superframe duration.

9. The method for controlling beacon reception in a wireless personal area network device according to claim 8, wherein the power-saving order is set within a range permitted by the beacon order.

10. The method for controlling beacon reception in a wireless personal area network device according to claim 8, wherein the power-saving interval is set within a time period for processing medium access control.
